(19) United States
(12) Patent Application Publication
(10) Pub. No.: US 2024/0138489 A1
(43) Pub. Date: May 2, 2024

(54) AEROSOL-GENERATING DEVICE AND OPERATION METHOD THEREOF

(71) Applicant: KT&G CORPORATION, Daejeon (KR)

(72) Inventor: Hyungjin JUNG, Seoul (KR)

(73) Assignee: KT&G CORPORATION, Daejeon (KR)

(21) Appl. No.: 18/548,824

(22) PCT Filed: Nov. 30, 2021
(86) PCT No.: PCT/KR2021/017903

§ 371 Date: Sep. 1, 2023

(30) Foreign Application Priority Data
Dec. 22, 2020 (KR) 10-2020-0181200

(51) Int. Cl. A24F 40/57; A24F 40/20; A24F 40/465; A24F 40/51; A24F 40/53; A24F 40/65

(52) U.S. Cl. CPC A24F 40/57; A24F 40/20; A24F 40/465; A24F 40/51; A24F 40/53; A24F 40/65

(57) ABSTRACT

An aerosol-generating device is disclosed. The aerosol-generating device of the present disclosure includes an aerosol-generating module including at least one heater configured to heat an aerosol-generating substance, a battery configured to supply electric power to the heater, a sensor module including at least one sensor configured to sense inhalation by a user, a memory, and a controller configured to control the electric power supplied to the heater. The controller determines an inhalation pattern associated with inhalation by the user based on a signal received from the sensor module, determines a temperature profile corresponding to the inhalation pattern based on the determined inhalation pattern when the determined inhalation pattern differs from a previous inhalation pattern, and controls the electric power supplied to the heater based on the temperature profile corresponding to the inhalation pattern.

### CROSS-REFERENCE TO RELATED APPLICATION(S)

This application is the National Stage filing under 35 U.S.C. 371 of International Application No. PCT/KR2021/017903, filed on Nov. 30, 2021, which claims the benefit of earlier filing date and right of priority to Korean Application No. 10-2020-0181200, filed on Dec. 22, 2020, the contents of which are all incorporated by reference herein in their entirety.

### TECHNICAL FIELD

The present disclosure relates to an aerosol-generating device and an operation method thereof.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE

### Technical Problem

It is an object of the present disclosure to solve the above and other problems.

It is another object of the present disclosure to provide an aerosol-generating device and an operation method thereof capable of determining a user's inhalation pattern and generating an amount of smoke corresponding to the user's inhalation pattern when the user inhales an aerosol.

### Technical Solution

An aerosol-generating device according to various embodiments of the present disclosure for accomplishing the above and other objects may include an aerosol-generating module including at least one heater configured to heat an aerosol-generating substance, a battery configured to supply electric power to the at least one heater, a sensor module including at least one sensor configured to sense inhalation by a user, a memory, and a controller configured to control the electric power supplied to the at least one heater. The controller may determine an inhalation pattern associated with inhalation by the user based on a signal received from the sensor module, may determine a temperature profile corresponding to the inhalation pattern based on the determined inhalation pattern when the determined inhalation pattern differs from a previous inhalation pattern, and may control the electric power supplied to the at least one heater based on the temperature profile corresponding to the inhalation pattern.

An operation method of an aerosol-generating device according to various embodiments of the present disclosure for accomplishing the above and other objects may include an operation of determining an inhalation pattern associated with inhalation by a user based on a signal received from a sensor module including at least one sensor configured to sense inhalation by the user, an operation of determining a temperature profile corresponding to the inhalation pattern based on the determined inhalation pattern when the determined inhalation pattern differs from a previous inhalation pattern, and an operation of supplying electric power to a heater configured to heat an aerosol-generating substance based on the temperature profile corresponding to the inhalation pattern.

### Advantageous Effects

According to at least one of embodiments of the present disclosure, a temperature profile corresponding to a user may be determined based on the user's inhalation pattern, such as an inhalation intensity or an inhalation time period, and thereafter, when the user inhales an aerosol, the electric power supplied to a heater may be controlled based on the temperature profile corresponding to the user, thus providing an optimum amount of smoke to the user.

In addition, according to at least one of embodiments of the present disclosure, a target temperature and an amount of electric power per unit time may be optimized according to a preheating section of the temperature profile and a heating section of the temperature profile based on the user's inhalation pattern, thereby providing an amount of smoke more suitable for the user's inhalation pattern.

In addition, according to at least one of embodiments of the present disclosure, whether the user's inhalation pattern changes may be monitored, and whether to update an existing setting according to the changed inhalation pattern may be suggested to the user, thereby increasing the reliability of the product and improving user satisfaction therewith.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2A to 4 are views for explaining the aerosol-generating device according to embodiments of the present disclosure;

FIG. 5 is a flowchart showing an operation method of the aerosol-generating device according to an embodiment of the present disclosure;

FIGS. 6 to 9 are views for explaining the operation of the aerosol-generating device;

FIG. 10 is a flowchart showing an operation method of the aerosol-generating device according to another embodiment of the present disclosure;

FIG. 11 is a view for explaining the operation method shown in FIG. 10;

FIG. 12 is a flowchart showing an operation method of the aerosol-generating device according to another embodiment of the present disclosure;

FIGS. 13 and 14 are views for explaining the operation method shown in FIG. 12; and

FIG. 15 is a flowchart showing an operation method of the aerosol-generating device according to another embodiment of the present disclosure.

### BEST MODE

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

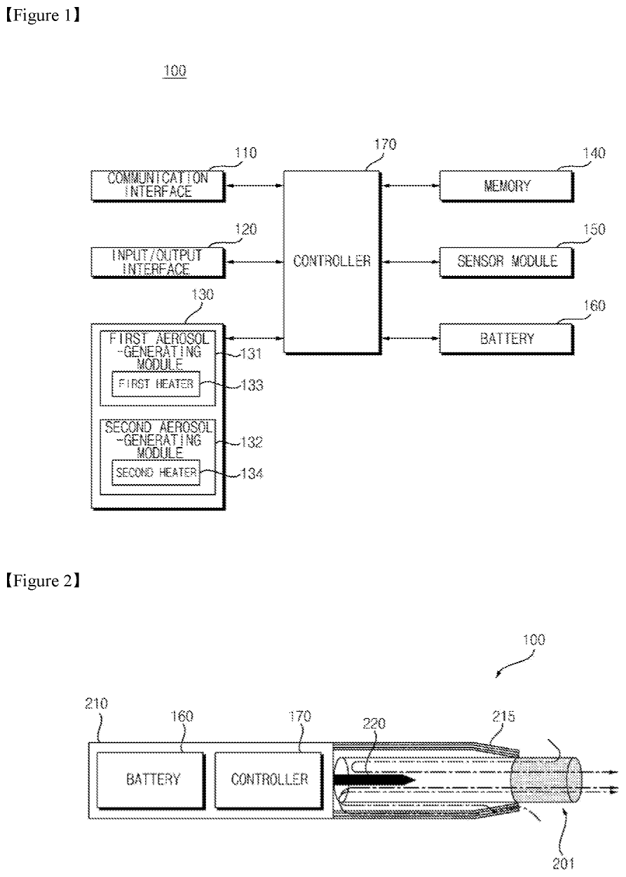

FIG. 1 is a block diagram of an aerosol-generating device according to an embodiment of the present disclosure.

Referring to FIG. 1, an aerosol-generating device 100 may include a communication interface 110, an input/output interface 120, an aerosol-generating module 130, a memory 140, a sensor module 150, a battery 160, and/or a controller 170.

In one embodiment, the aerosol-generating device 100 may be composed only of a main body. In this case, components included in the aerosol-generating device 100 may be located in the main body. In another embodiment, the aerosol-generating device 100 may be composed of a cartridge, which contains an aerosol-generating substance, and a main body. In this case, the components included in the aerosol-generating device 100 may be located in at least one of the main body or the cartridge.

The communication interface 110 may include at least one communication module for communication with an external device and/or a network. For example, the communication interface 110 may include a communication module for wired communication, such as a Universal Serial Bus (USB). For example, the communication interface 110 may include a communication module for wireless communication, such as Wireless Fidelity (Wi-Fi), Bluetooth, Bluetooth Low Energy (BLE), ZigBee, or nearfield communication (NFC).

The input/output interface 120 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output interface 120 may transmit data corresponding to a command input by the user through the input device to another component (or other components) of the aerosol-generating device 100, and may output information corresponding to data received from another component (or other components) of the aerosol-generating device 100 through the output device.

The aerosol-generating module 130 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 130 may include at least one heater (not shown).

The aerosol-generating module 130 may include an electro-resistive heater. For example, the electro-resistive heater may include at least one electrically conductive track, and may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 130 may include a heater that uses an induction-heating method. For example, the induction heater may include an electrically conductive coil, and may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss, and the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 130 may generate ultrasonic vibrations to thereby generate an aerosol from the aerosol-generating substance.

The aerosol-generating device 100 may include a plurality of aerosol-generating modules 130. For example, the aerosol-generating device 100 may include a first aerosol-generating module 131 for generating an aerosol by vaporizing a liquid material and a second aerosol-generating module 132 for generating an aerosol by heating a cigarette. A first heater 133 included in the first aerosol-generating module 131 may be a coil heater or a mesh heater. The first aerosol-generating module 131 may be implemented in the form of a cartridge, which is provided separately from the aerosol-generating device 100. The first aerosol-generating module 131 may be referred to as a cartomizer, an atomizer, or a vaporizer. A second heater 134 included in the second aerosol-generating module 132 may be a film heater including an electrically conductive track, or may be a susceptor configured to generate heat using an induction-heating method.

The memory 140 may store programs for processing and controlling each signal in the controller 170, and may store processed data and data to be processed.

For example, the memory 140 may store applications designed for the purpose of performing various tasks that can be processed by the controller 170, and may selectively provide some of the stored applications in response to the request from the controller 170.

For example, the memory 140 may store data on the operation time of the aerosol-generating device 100, the maximum number of puffs, the current number of puffs, at least one temperature profile, and the user's inhalation pattern. Here, “puff” means inhalation by the user, and “inhalation” means the user's act of taking air or other substances into the user's oral cavity, nasal cavity, or lungs through the user's mouth or nose.

The memory 140 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 150 may include at least one sensor.

For example, the sensor module 150 may include a sensor for sensing a puff (hereinafter referred to as a “puff sensor”). In this case, the puff sensor may be implemented as a pressure sensor.

For example, the sensor module 150 may include a sensor for sensing the temperature of the heater included in the aerosol-generating module 130 and the temperature of the aerosol-generating substance (hereinafter referred to as a “temperature sensor”). In this case, the heater included in the aerosol-generating module 130 may also serve as the temperature sensor. For example, the electro-resistive material of the heater may be a material having a predetermined temperature coefficient of resistance. The sensor module 150 may measure the resistance of the heater, which varies according to the temperature, to thereby sense the temperature of the heater.

For example, in the case in which the main body of the aerosol-generating device 100 is formed to allow a cigarette to be inserted thereinto, the sensor module 150 may include a sensor for sensing insertion of the cigarette (hereinafter referred to as a “cigarette detection sensor”).

For example, in the case in which the aerosol-generating device 100 includes a cartridge, the sensor module 150 may include a sensor for sensing mounting/demounting of the cartridge and the position of the cartridge (hereinafter referred to as a “cartridge detection sensor”).

In this case, the cigarette detection sensor and/or the cartridge detection sensor may be implemented as an inductance-based sensor, a capacitive sensor, a resistance sensor, or a Hall sensor (or Hall IC) using a Hall effect.

For example, the sensor module 150 may include a voltage sensor for sensing a voltage applied to a component (e.g. the battery 160) provided in the aerosol-generating device 100 and/or a current sensor for sensing a current.

The battery 160 may supply electric power used for the operation of the aerosol-generating device 100 under the control of the controller 170. The battery 160 may supply electric power to other components provided in the aerosol-generating device 100, for example, the communication module included in the communication interface 110, the output device included in the input/output interface 120, and the heater included in the aerosol-generating module 130.

The battery 160 may be a rechargeable battery or a disposable battery. For example, the battery 160 may be a lithium-ion (Li-ion) battery or a lithium polymer (Li-polymer) battery. However, the present disclosure is not limited thereto. For example, when the battery 160 is rechargeable, the charging rate (C-rate) of the battery 160 may be 10 C, and the discharging rate (C-rate) thereof may be 10 C to 20 C. However, the present disclosure is not limited thereto. Also, for stable use, the battery 160 may be manufactured such that 80% or more of the total capacity may be ensured even when charging/discharging is performed 2000 times.

The aerosol-generating device 100 may further include a battery protection circuit module (PCM) (not shown), which is a circuit for protecting the battery 160. The battery protection circuit module (PCM) may be disposed adjacent to the upper surface of the battery 160. For example, in order to prevent overcharging and overdischarging of the battery 160, the battery protection circuit module (PCM) may cut off the electrical path to the battery 160 when a short circuit occurs in a circuit connected to the battery 160, when an overvoltage is applied to the battery 160, or when an overcurrent flows through the battery 160.

The aerosol-generating device 100 may further include a power terminal (not shown) to which electric power supplied from the outside is input. For example, a power line may be connected to the power terminal, which is disposed at one side of the main body of the aerosol-generating device 100, and the aerosol-generating device 100 may use the electric power supplied through the power line connected to the power terminal to charge the battery 160. In this case, the power terminal may be a wired terminal for USB communication.

The aerosol-generating device 100 may wirelessly receive electric power supplied from the outside through the communication interface 110. For example, the aerosol-generating device 100 may wirelessly receive electric power using an antenna included in the communication module for wireless communication, and may charge the battery 160 using the wirelessly supplied electric power.

The controller 170 may control the overall operation of the aerosol-generating device 100. The controller 170 may be connected to each of the components provided in the aerosol-generating device 100, and may transmit and/or receive a signal to and/or from each of the components, thereby controlling the overall operation of each of the components.

The controller 170 may include at least one processor, and may control the overall operation of the aerosol-generating device 100 using the processor included therein. Here, the processor may be a general processor such as a central processing unit (CPU). Of course, the processor may be a dedicated device such as an application-specific integrated circuit (ASIC), or may be any of other hardware-based processors.

The controller 170 may perform any one of a plurality of functions of the aerosol-generating device 100. For example, the controller 170 may perform any one of a plurality of functions of the aerosol-generating device 100 (e.g. a preheating function, a heating function, a charging function, and a cleaning function) according to the state of each of the components provided in the aerosol-generating device 100 and the user's command received through the input/output interface 120.

The controller 170 may control the operation of each of the components provided in the aerosol-generating device 100 based on data stored in the memory 140. For example, the controller 170 may control the supply of a predetermined amount of electric power from the battery 160 to the aerosol-generating module 130 based on the data on the temperature profile and the user's inhalation pattern, which is stored in the memory 140.

The controller 170 may determine the occurrence or non-occurrence of a puff using the puff sensor included in the sensor module 150. For example, the controller 170 may check a temperature change, a flow change, a pressure change, and a voltage change in the aerosol-generating device 100 based on the values sensed by the puff sensor, and may determine the occurrence or non-occurrence of a puff based on the result of the checking.

The controller 170 may control the operation of each of the components provided in the aerosol-generating device 100 according to the occurrence or non-occurrence of a puff and/or the number of puffs. For example, upon determining that a puff has occurred, the controller 170 may perform control such that a predetermined amount of electric power is supplied to the heater according to the temperature profile stored in the memory 140. For example, the controller 170 may perform control such that the temperature of the heater is changed or maintained based on the temperature profile stored in the memory 140.

The controller 170 may perform control such that the supply of electric power to the heater is interrupted according to a predetermined condition. For example, the controller 170 may perform control such that the supply of electric power to the heater is interrupted when the cigarette is removed, when the cartridge is demounted, when the number of puffs reaches the predetermined maximum number of puffs, when a puff is not sensed during a predetermined period of time or longer, or when the remaining capacity of the battery 160 is less than a predetermined value.

The controller 170 may calculate the remaining capacity with respect to the full charge capacity of the battery 160. For example, the controller 170 may calculate the remaining capacity of the battery 160 based on the values sensed by the voltage sensor and/or the current sensor included in the sensor module 150.

FIGS. 2A to 4 are views for explaining the aerosol-generating device according to embodiments of the present disclosure.

According to various embodiments of the present disclosure, the aerosol-generating device 100 may include a main body and/or a cartridge.

Referring to FIG. 2A, the aerosol-generating device 100 according to an embodiment may include a main body 210, which is formed such that a cigarette 201 can be inserted into the inner space formed by a housing 215.

The cigarette 201 may be similar to a general combustive cigarette. For example, the cigarette 201 may be divided into a first portion including an aerosol-generating substance and a second portion including a filter. Alternatively, the second portion of the cigarette 201 may also include an aerosol-generating substance. For example, a granular or capsular flavoring material may be inserted into the second portion.

The entirety of the first portion may be inserted into the aerosol-generating device 100, and the second portion may be exposed to the outside. Alternatively, only a portion of the first portion may be inserted into the aerosol-generating device 100. Alternatively, the entirety of the first portion and a portion of the second portion may be inserted into the aerosol-generating device 100. The user may inhale the aerosol in the state of holding the second portion in the mouth. At this time, the aerosol may be generated as external air passes through the first portion, and the generated aerosol may pass through the second portion to be introduced into the mouth of the user.

The main body 210 may be structured such that external air is introduced into the main body 210 in the state in which the cigarette 201 is inserted thereinto. In this case, the external air introduced into the main body 210 may flow into the mouth of the user via the cigarette 201.

When the cigarette 201 is inserted, the controller 170 may perform control such that electric power is supplied to the heater based on the temperature profile stored in the memory 140.

The controller 170 may perform control such that electric power is supplied to the heater using at least one of a pulse width modulation (PWM) method or a proportional-integral-differential (PID) method.

For example, the controller 170 may perform control such that a current pulse having a predetermined frequency and a predetermined duty ratio is supplied to the heater using the PWM method. In this case, the controller 170 may control the amount of electric power supplied to the heater by adjusting the frequency and the duty ratio of the current pulse.

For example, the controller 170 may determine a target temperature to be controlled based on the temperature profile. In this case, the controller 170 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

The heater may be disposed in the main body 210 at a position corresponding to the position at which the cigarette 201 is inserted into the main body 210. Although it is illustrated in the drawings that the heater is an electrically conductive heater 220 including a needle-shaped electrically conductive track, the present disclosure is not limited thereto.

The heater may heat the interior and/or exterior of the cigarette 201 using the electric power supplied from the battery 160, and an aerosol may be generated from the heated cigarette 201. At this time, the user may hold one end of the cigarette 201 in the mouth to inhale the aerosol containing a tobacco material.

Meanwhile, the controller 170 may perform control such that electric power is supplied to the heater in the state in which the cigarette 201 is not inserted into the main body according to a predetermined condition. For example, when a cleaning function for cleaning the space into which the cigarette 201 is inserted is selected in response to a command input by the user through the input/output interface 120, the controller 170 may perform control such that a predetermined amount of electric power is supplied to the heater.

The controller 170 may monitor the number of puffs based on the value sensed by the puff sensor from the time point at which the cigarette 201 was inserted into the main body.

When the cigarette 201 is removed from the main body, the controller 170 may initialize the current number of puffs stored in the memory 140.

Referring to FIG. 2B, the cigarette 201 according to an embodiment may include a tobacco rod 202 and a filter rod 203. The first portion described above with reference to FIG. 2A may include the tobacco rod 202, and the second portion may include the filter rod 203.

Although it is illustrated in FIG. 2B that the filter rod 203 is composed of a single segment, the present disclosure is not limited thereto. In other words, the filter rod 203 may be composed of a plurality of segments. For example, the filter rod 203 may include a first segment configured to cool an aerosol and a second segment configured to remove a predetermined component included in the aerosol. In addition, the filter rod 203 may further include at least one segment configured to perform other functions, as needed.

The cigarette 201 may be packed using at least one wrapper 205. The wrapper 205 may have at least one hole formed therein to allow external air to be introduced thereinto or to allow internal gas to be discharged therefrom. In one example, the cigarette 201 may be packed using one wrapper 205. In another example, the cigarette 201 may be doubly packed using two or more wrappers 205. For example, the tobacco rod 202 may be packed using a first wrapper, and the filter rod 203 may be packed using a second wrapper. Also, the tobacco rod 202 and the filter rod 203, which are individually packed using separate wrappers, may be coupled to each other, and the entire cigarette 201 may be packed using a third wrapper. When each of the tobacco rod 202 and the filter rod 203 is composed of a plurality of segments, each segment may be packed using a separate wrapper. Also, the entire cigarette 201, formed by coupling segments, each of which is packed using a separate wrapper, to each other, may be packed using another wrapper.

The tobacco rod 202 may include an aerosol-generating substance. For example, the aerosol-generating substance may include at least one of glycerin, propylene glycol, ethylene glycol, dipropylene glycol, diethylene glycol, triethylene glycol, tetraethylene glycol, or oleyl alcohol, but the present disclosure is not limited thereto. Also, the tobacco rod 202 may include other additives, such as a flavoring agent, a wetting agent, and/or an organic acid. Also, a flavoring liquid, such as menthol or a moisturizer, may be injected into and added to the tobacco rod 202.

The tobacco rod 202 may be manufactured in various forms. For example, the tobacco rod 202 may be formed as a sheet or a strand. Also, the tobacco rod 202 may be formed as shredded tobacco, which is formed by cutting a tobacco sheet into tiny bits. Also, the tobacco rod 202 may be surrounded by a thermally conductive material. For example, the thermally conductive material may be a metal foil such as aluminum foil, but the present disclosure is not limited thereto. In one example, the thermally conductive material surrounding the tobacco rod 202 may uniformly distribute heat transmitted to the tobacco rod 202, thereby improving conduction of the heat applied to the tobacco rod and thus improving the taste of the tobacco. Also, the thermally conductive material surrounding the tobacco rod 202 may function as a susceptor that is heated by the induction heater. Here, although not illustrated in the drawings, the tobacco rod 202 may further include an additional susceptor, in addition to the thermally conductive material surrounding the tobacco rod 202.

The filter rod 203 may be a cellulose acetate filter. The filter rod 203 may be formed in any of various shapes. For example, the filter rod 203 may be a cylinder-type rod or a hollow tube-type rod. Also, the filter rod 203 may be a recess-type rod. When the filter rod 203 is composed of a plurality of segments, at least one of the plurality of segments may be formed in a different shape.

The filter rod 203 may be formed to generate flavors. In one example, a flavoring liquid may be injected into the filter rod 203, or a separate fiber coated with a flavoring liquid may be inserted into the filter rod 203.

In addition, the filter rod 203 may include at least one capsule 204. Here, the capsule 204 may function to generate a flavor, or may function to generate an aerosol. For example, the capsule 204 may have a structure in which a liquid containing a flavoring material is wrapped with a film. The capsule 204 may have a spherical or cylindrical shape, but the present disclosure is not limited thereto.

When the filter rod 203 includes a segment configured to cool the aerosol, the cooling segment may be made of a polymer material or a biodegradable polymer material. For example, the cooling segment may be made of pure polylactic acid alone, but the present disclosure is not limited thereto. Alternatively, the cooling segment may be formed as a cellulose acetate filter having a plurality of holes formed therein. However, the cooling segment is not limited to the above-described example, and any other type of cooling segment may be used, so long as the same is capable of cooling the aerosol.

Although not illustrated in FIG. 2B, the cigarette 201 according to an embodiment may further include a front-end filter. The front-end filter may be located at the side of the tobacco rod 202 that faces the filter rod 203. The front-end filter may prevent the tobacco rod 202 from becoming detached outwards, and may prevent a liquefied aerosol from flowing into the aerosol-generating device 100 from the tobacco rod 202 during inhalation by the user.

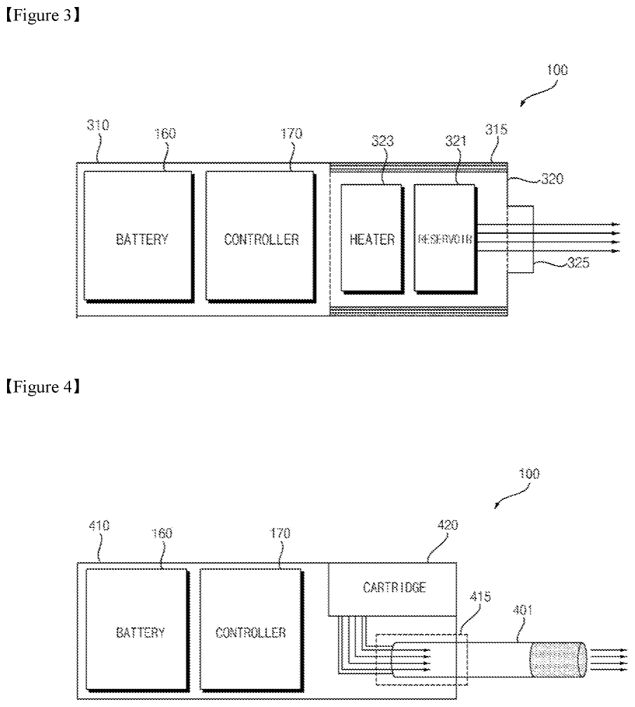

Referring to FIG. 3, the aerosol-generating device 100 according to an embodiment may include a main body 310 and a cartridge 320. The main body 310 may support the cartridge 320, and the cartridge 320 may contain an aerosol-generating substance.

According to one embodiment, the cartridge 320 may be configured so as to be detachably mounted to the main body 310. According to another embodiment, the cartridge 320 may be formed integrally with the main body 310. For example, the cartridge 320 may be mounted to the main body 310 in a manner such that at least a portion of the cartridge 320 is inserted into the inner space formed by a housing 315 of the main body 310.

The main body 310 may be formed to have a structure in which external air can be introduced into the main body 310 in the state in which the cartridge 320 is inserted thereinto. Here, the external air introduced into the main body 310 may flow into the user's mouth via the cartridge 320.

The controller 170 may determine whether the cartridge 320 is in a mounted state or a detached state using a cartridge detection sensor included in the sensor module 150. For example, the cartridge detection sensor may transmit a pulse current through a terminal connected to the cartridge, and may determine whether the pulse current is received through another terminal, thereby detecting whether the cartridge is in a connected state.

The cartridge 320 may include a reservoir 321 configured to contain the aerosol-generating substance and/or a heater 323 configured to heat the aerosol-generating substance in the reservoir 321. For example, a liquid delivery element impregnated with (containing) the aerosol-generating substance may be disposed inside the reservoir 321, and the electrically conductive track of the heater 323 may be formed in a structure that is wound around the liquid delivery element. In this case, when the liquid delivery element is heated by the heater 323, an aerosol may be generated. Here, the liquid delivery element may include a wick made of, for example, cotton fiber, ceramic fiber, glass fiber, or porous ceramic.

The cartridge 320 may include a mouthpiece 325. Here, the mouthpiece 325 may be a portion to be inserted into a user's oral cavity, and may have a discharge hole through which the aerosol is discharged to the outside during a puff.

Referring to FIG. 4, the aerosol-generating device 100 according to an embodiment may include a main body 410 and a cartridge 420. The main body 410 may be formed so as to support the cartridge 420 and to allow a cigarette 401 to be inserted into an inner space 415 therein, and the cartridge 420 may contain an aerosol-generating substance.

The aerosol-generating device 100 may include a first heater for heating the aerosol-generating substance stored in the cartridge 420. For example, when the user holds one end of the cigarette 401 in the mouth to inhale the aerosol, the aerosol generated by the first heater may pass through the cigarette 401. At this time, while the aerosol passes through the cigarette 401, a tobacco material may be added to the aerosol, and the aerosol containing the tobacco material may be drawn into the user's oral cavity through one end of the cigarette 401.

Alternatively, according to another embodiment, the aerosol-generating device 100 may include a first heater for heating the aerosol-generating substance stored in the cartridge 420 and a second heater for heating the cigarette 401 inserted into the main body 410. For example, the aerosol-generating device 100 may generate an aerosol by heating the aerosol-generating substance stored in the cartridge 420 and the cigarette 401 using the first heater and the second heater, respectively.

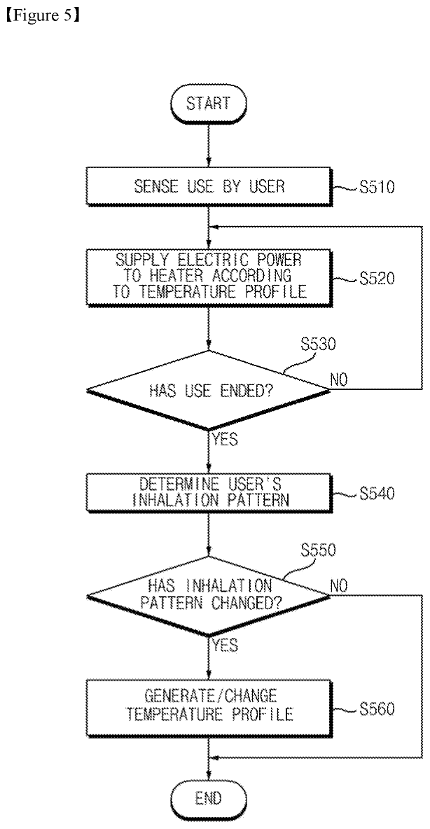

FIG. 5 is a flowchart showing an operation method of the aerosol-generating device according to an embodiment of the present disclosure.

Referring to FIG. 5, the aerosol-generating device 100 may sense use thereof by the user in operation S510. For example, the aerosol-generating device 100 may sense use thereof by the user when insertion of a cigarette is sensed by the cigarette detection sensor or when a command to turn on the power is received through the input device.

When use thereof by the user is sensed, the aerosol-generating device 100 may supply electric power to the heater of the aerosol-generating module 130 based on the temperature profile stored in the memory 140 in operation S520.

When use thereof by the user is sensed, the aerosol-generating device 100 may determine whether a puff is sensed using at least one sensor included in the sensor module 150.

For example, the aerosol-generating device 100 may include a pressure sensor (not shown) configured to sense the pressure in a flow path through which air flows when the user inhales, and may sense a puff based on a change in the pressure sensed by the pressure sensor.

For example, the aerosol-generating device 100 may include a flow sensor configured to sense the flow rate in the flow path through which air flows when the user inhales, and may sense a puff based on a change in the flow rate sensed by the flow sensor.

Hereinafter, the embodiment will be described based on sensing of pressure by the pressure sensor. However, the present disclosure is not limited thereto, and may be understood based on any of various sensors implementing the puff sensor.

The aerosol-generating device 100 may store the value sensed by at least one sensor included in the sensor module 150 in the memory 140.

For example, the aerosol-generating device 100 may store data on a change in the pressure over time, sensed by the pressure sensor, in the memory 140.

For example, the aerosol-generating device 100 may convert data on a change in the pressure in a time domain into a frequency domain, and may store the data converted into the frequency domain in the memory 140.

For example, based on the temperature profile stored in the memory 140, the aerosol-generating device 100 may control the electric power supplied to the heater using a PWM method in a preheating section, and may control the electric power supplied to the heater using a PID method in a heating section.

For example, based on the temperature profile stored in the memory 140, when a puff is sensed, the aerosol-generating device 100 may supply predetermined first electric power to the heater during a predetermined period of heating time, and while a puff is not sensed, the aerosol-generating device 100 may supply second electric power, the magnitude of which is lower than that of the first electric power, to the heater.

For example, in the case of including a plurality of aerosol-generating modules 131 and 132, the aerosol-generating device 100 may supply electric power to the first heater 133 based on a first temperature profile, among the plurality of temperature profiles stored in the memory 140, and may supply electric power to the second heater 134 based on a second temperature profile, among the plurality of temperature profiles stored in the memory 140.

The aerosol-generating device 100 may determine whether the user terminates use thereof in operation S530.

For example, when removal of the cigarette is sensed by the cigarette detection sensor or when a command to turn off the power is received through the input device, the aerosol-generating device 100 may determine that the user terminates use thereof.

For example, when a predetermined period of time (e.g. 5 minutes) has elapsed from the time point at which use thereof by the user was sensed, the aerosol-generating device 100 may determine that use thereof by the user has ended.

For example, the aerosol-generating device 100 may monitor the number of puffs from the time point at which the first puff was sensed. When the number of puffs reaches the maximum number of puffs, the aerosol-generating device 100 may determine that use thereof by the user has ended.

When the user terminates use thereof, the aerosol-generating device 100 may determine the user's inhalation pattern in operation S540.

The aerosol-generating device 100 may calculate the intensity of user's inhalation, the total inhalation amount, the inhalation amount per unit time, the time interval between puffs (hereinafter referred to as the “puff interval”), and/or the inhalation time period based on the values sensed by at least one sensor, which are stored in the memory 140.

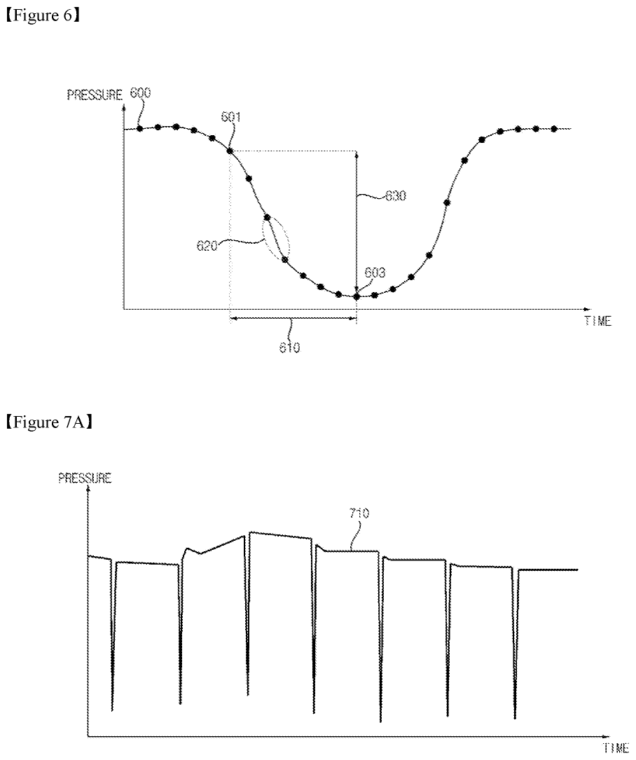

Referring to FIG. 6, values sensed by the pressure sensor when the user inhales may be checked.

The aerosol-generating device 100 may calculate a sample pressure value 600 using at least some of the pressure values sensed by the pressure sensor. For example, the aerosol-generating device 100 may calculate a representative value (e.g. an average value or a median value) of the pressure values continuously sensed during a predetermined time period as the sample pressure value 600. The time interval between the sample pressure values 600 may be uniform.

The aerosol-generating device 100 may calculate a slope between the sample pressure values 600.

When the slope between the sample pressure values 600 is less than a first reference, the aerosol-generating device 100 may determine that a puff occurs. Here, the first reference may be set as a minimum level of pressure change (e.g. −4 hpa/ms) at which it can be determined that the pressure has decreased due to the user's inhalation.

Also, the aerosol-generating device 100 may select a first sample pressure value 601, obtained when the slope between the sample pressure values 600 is less than the first reference, as a reference pressure value, and may determine the time point corresponding to the first sample pressure value 601 to be a puff occurrence time. The puff occurrence time may be referred to as a puff starting time.

On the other hand, when the slope between the sample pressure values 600 becomes equal to or greater than a second reference after the puff occurrence time, the aerosol-generating device 100 may determine that the puff ends. Here, the second reference may be set as a pressure change (e.g. −0.2 hpa/ms) at which it can be determined that the pressure is no longer being lowered by the user's inhalation.

Also, the aerosol-generating device 100 may select a second sample pressure value 603, obtained when the slope between the sample pressure values 600 is equal to or greater than the second reference, as a minimum pressure value, and may determine the time point corresponding to the second sample pressure value 603 to be a puff ending time.

The aerosol-generating device 100 may determine the time period 610 from the puff occurrence time to the puff ending time to be a user's inhalation time period.

The aerosol-generating device 100 may calculate the inhalation intensity based on the time period 610 from the puff occurrence time to the puff ending time, the largest slope 620 among the slopes calculated from the puff occurrence time, the second sample pressure value 603 selected as the minimum pressure value, and/or the difference 630 between the reference pressure value and the minimum pressure value.

For example, the aerosol-generating device 100 may calculate the inhalation intensity in consideration of the magnitude of the largest slope 620, among the slopes calculated from the puff occurrence time to the puff ending time.

For example, the aerosol-generating device 100 may calculate the inhalation intensity in response to the ratio of the difference 630 between the reference pressure value and the minimum pressure value to the time period 610 from the puff occurrence time to the puff ending time.

For example, the aerosol-generating device 100 may calculate the inhalation intensity in response to the second sample pressure value 603, selected as the minimum pressure value.

Also, the aerosol-generating device 100 may calculate the total inhalation amount and/or the inhalation amount per unit time during a puff.

For example, the aerosol-generating device 100 may calculate the total inhalation amount based on the result of integrating the graph of the values sensed by the pressure sensor in the time domain, and may determine the result of dividing the calculated total inhalation amount by the inhalation time period to be the inhalation amount per unit time.

For example, the aerosol-generating device 100 may calculate the total inhalation amount based on a predetermined calculation formula using the inhalation intensity and the inhalation time period as independent variables, and may determine the result of dividing the calculated total inhalation amount by the inhalation time period to be the inhalation amount per unit time.

On the other hand, the aerosol-generating device 100 may calculate the inhalation intensity, the total inhalation amount, the inhalation amount per unit time, and/or the inhalation time period for each of the multiple puff sections that constitute the heating section, and may determine a user's inhalation pattern based on the inhalation intensity, the total inhalation amount, the inhalation amount per unit time, and/or the inhalation time period calculated for each of the multiple puff sections.

For example, the aerosol-generating device 100 may determine a representative value (e.g. an average value or a median value) of the inhalation intensities calculated for each of the multiple puff sections to be the user's inhalation intensity.

For example, the aerosol-generating device 100 may determine a representative value of the total inhalation amounts calculated for each of the multiple puff sections to be the user's total inhalation amount.

For example, the aerosol-generating device 100 may determine a representative value of the inhalation amounts per unit time calculated for each of the multiple puff sections to be the user's inhalation amount per unit time.

For example, the aerosol-generating device 100 may determine a representative value of the inhalation time periods calculated for each of the multiple puff sections to be the user's inhalation time period.

For example, the aerosol-generating device 100 may determine a representative value of the puff intervals calculated for each of the multiple puff sections to be the user's puff interval.

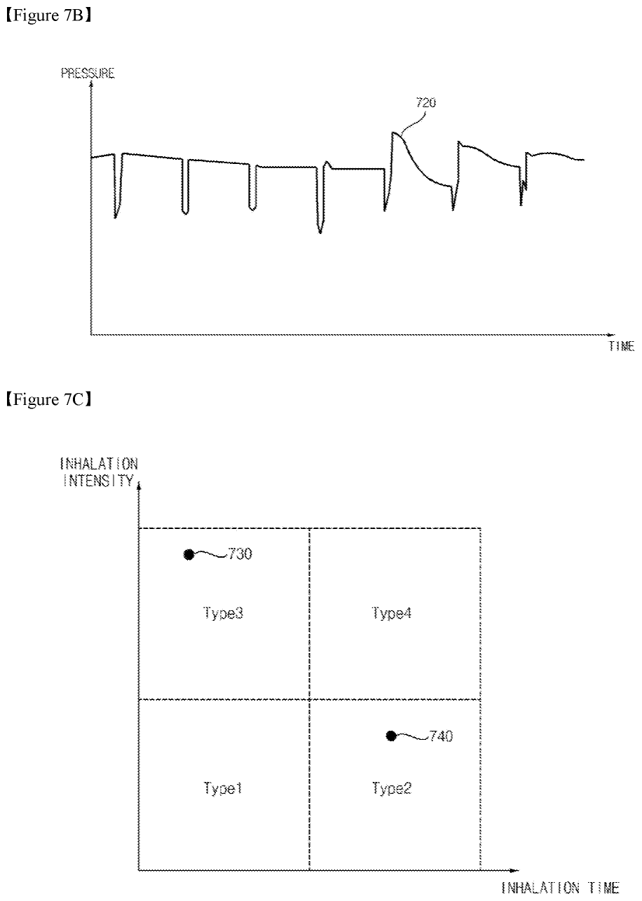

FIGS. 7A and 7B show graphs 710 and 720 indicating values sensed by the pressure sensor for the multiple puff sections that constitute the heating section. Here, based on the inhalation intensity calculated for each of the multiple puff sections, for example, the minimum pressure value during a puff, it can be seen that the inhalation intensity at which the user inhales the aerosol as indicated by the first graph 710 is larger than the inhalation intensity at which the user inhales the aerosol as indicated by the second graph 720.

FIG. 7C shows a user's inhalation pattern according to the inhalation time period and the inhalation intensity. Here, in the case 730 in which the user inhales the aerosol as indicated by the first graph 710 of FIG. 7A, the user's inhalation pattern may correspond to “Type 3”, in which the inhalation intensity is relatively high and the inhalation time period is relatively short. Also, in the case 740 in which the user inhales the aerosol as indicated by the second graph 720 of FIG. 7B, the user's inhalation pattern may correspond to “Type 2”, in which the inhalation intensity is relatively low and the inhalation time period is relatively long.

Although it is illustrated in FIG. 7C that the user's inhalation pattern is classified as “Type 1” to “Type 4” according to the inhalation intensity and the inhalation time period, the present disclosure is not limited thereto. For example, the user's inhalation pattern may also be classified according to the user's total inhalation amount, the inhalation amount per unit time, or the puff interval.

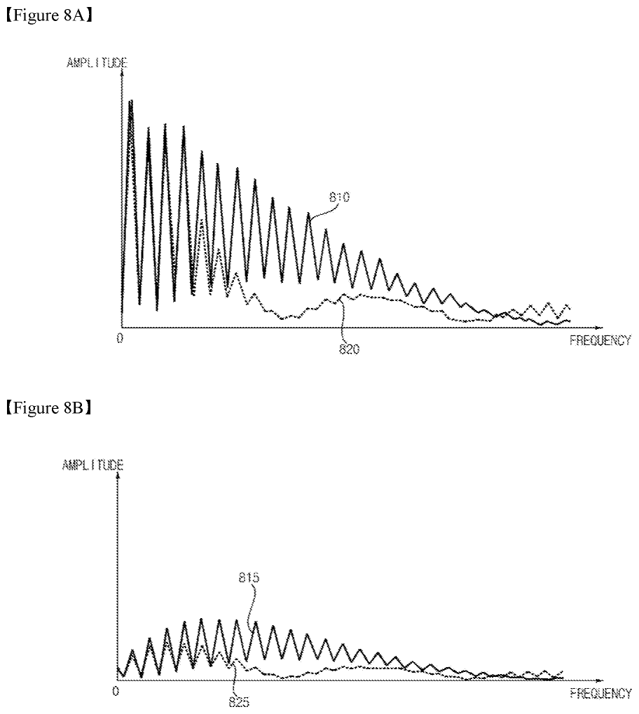

FIG. 8A is a view showing graphs 810 and 820 indicating values sensed by the pressure sensor that have been converted into the frequency domain. Here, it can be seen that the graphs 810 and 820 in the frequency domain differ from each other according to the user's inhalation pattern.

The aerosol-generating device 100 may determine the user's inhalation pattern based on the graphs 810 and 820 in the frequency domain. The aerosol-generating device 100 may remove noise components in the graphs 810 and 820 in the frequency domain using a noise-filtering algorithm such as finite impulse response (FIR) or infinite impulse response (IIR), and may determine the user's inhalation pattern based on the result of removing the noise components. Here, the FIR filter or the IIR filter, which is a linear filter, may uniformly reduce the influence of the filter in every noise environment.

Also, the aerosol-generating device 100 may amplify the result value obtained by removing the noise component, and thereafter may determine the user's inhalation pattern.

FIG. 8B shows graphs 815 and 825 indicating values sensed by the pressure sensor in the frequency domain, which are obtained by removing the noise components in the graphs 810 and 820 shown in FIG. 8A. Here, the aerosol-generating device 100 may more accurately determine the user's inhalation pattern based on the graphs 815 and 825 from which the noise components have been removed.

Referring again to FIG. 5, the aerosol-generating device 100 may determine whether the user's inhalation pattern has changed in operation S550.

The aerosol-generating device 100 may compare the user's inhalation pattern determined in operation S540 (hereinafter referred to as the “current inhalation pattern”) with the user's inhalation pattern determined before operation S510 (hereinafter referred to as the “previous inhalation pattern”), and may determine that the user's inhalation pattern has changed when the current inhalation pattern and the previous inhalation pattern are different from each other.

For example, the aerosol-generating device 100 may respectively compare the user's inhalation intensity, the total inhalation amount, the inhalation amount per unit time, the puff interval, and/or the inhalation time period corresponding to the current inhalation pattern with the user's inhalation intensity, the total inhalation amount, the inhalation amount per unit time, the puff interval, and/or the inhalation time period corresponding to the previous inhalation pattern. When at least one of the user's inhalation intensity, the total inhalation amount, the inhalation amount per unit time, the puff interval, or the inhalation time period changes, for example, when the difference between the inhalation amounts per unit time is equal to or greater than a predetermined difference, the aerosol-generating device 100 may determine that the user's inhalation pattern has changed.

When the user's inhalation pattern changes, the aerosol-generating device 100 may generate a temperature profile corresponding to the changed inhalation pattern and may replace the temperature profile pre-stored in the memory 140 with the generated temperature profile in operation S560. For example, the aerosol-generating device 100 may determine the target temperature of the heater and the amount of electric power supplied to the heater per unit time based on the user's inhalation pattern.

The aerosol-generating device 100 may determine the target temperature of the heater and/or the amount of electric power supplied to the heater per unit time based on the user's inhalation intensity. For example, as the inhalation intensity increases, the aerosol-generating device 100 may determine the target temperature in the heating section to be higher. For example, as the inhalation intensity decreases, the aerosol-generating device 100 may determine the amount of electric power per unit time in the heating section to be smaller.

The aerosol-generating device 100 may determine the target temperature of the heater and/or the amount of electric power supplied to the heater per unit time based on the user's total inhalation amount. For example, as the user's total inhalation amount increases, the aerosol-generating device 100 may determine the target temperature in the preheating section to be lower and may determine the target temperature in the heating section to be higher. For example, as the user's total inhalation amount increases, the aerosol-generating device 100 may determine the amount of electric power per unit time in the preheating section to be smaller and may determine the amount of electric power per unit time in the heating section to be larger.

The aerosol-generating device 100 may determine the target temperature of the heater and/or the amount of electric power supplied to the heater per unit time based on the user's puff interval. For example, as the user's puff interval is longer, the aerosol-generating device 100 may determine the amount of electric power per unit time in the preheating section to be smaller.

The aerosol-generating device 100 may determine the heating time period for which the heater generates heat based on the user's inhalation time period. For example, as the user's inhalation time period is longer, the aerosol-generating device 100 may determine the heating time period corresponding to the heating section to be longer.

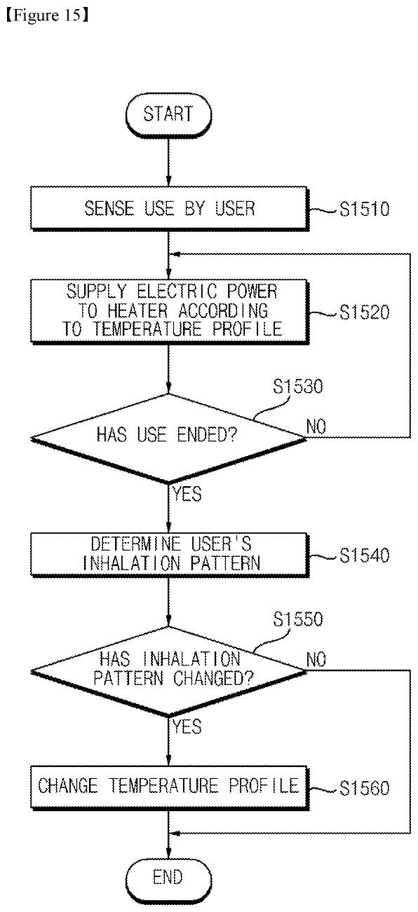

Also, the aerosol-generating device 100 may determine one of the plurality of temperature profiles pre-stored in the memory 140 to be the temperature profile corresponding to the user's inhalation pattern. This will be described later with reference to FIG. 15.

When the user's inhalation pattern changes, the aerosol-generating device 100 may output a message suggesting a setting change in response to the change in the inhalation pattern (hereinafter referred to as a “suggestion message”) through the output device of the input/output interface 120. When user input to change the setting in response to the change in the inhalation pattern is received through the input device of the input/output interface 120, the aerosol-generating device 100 may change the preset temperature profile to the temperature profile corresponding to the changed inhalation pattern.

When a setting is made such that the temperature profile is changed according to the user's inhalation pattern, the aerosol-generating device 100 may change the preset temperature profile to the temperature profile corresponding to the changed inhalation pattern without outputting a suggestion message. For example, the aerosol-generating device 100 may output a suggestion message through the output device of the input/output interface 120 at the time point at which use thereof by the user is sensed, and may make a setting such that the temperature profile is changed in response to the user input received through the input device of the input/output interface 120. For example, the aerosol-generating device 100 may transmit data including the suggestion message to an external device, which is connected thereto via a nearfield wireless communication network, through the communication interface 110, and may make a setting such that the temperature profile is changed in response to a control signal received from the external device.

Also, the aerosol-generating device 100 may transmit data on the value sensed by at least one sensor included in the sensor module 150 to a server (not shown) through the communication interface 110, and may receive a learning model, which is generated through learning of the sensed value using machine learning such as deep learning, from the server and store the same therein. Here, the server may be a device that is capable of processing data in various ways using at least one processor.

Also, the aerosol-generating device 100 may perform an operation of determining the user's inhalation pattern and an operation of generating the temperature profile using the learning model received from the server.

Machine learning means that, without a human directly teaching logic to an electronic device, the electronic device learns through data and thus solves problems for itself based thereon.

Deep learning is a method of teaching a human's way of thinking to an electronic device based on an artificial neural network (ANN), and is artificial intelligence technology enabling the electronic device to learn autonomously, like a human. The artificial neural network (ANN) may be implemented in the form of software or hardware, such as a chip. For example, the artificial neural network (ANN) may include various kinds of algorithms, such as a deep neural network (DNN), a convolutional neural network (CNN), a recurrent neural network (RNN), and a deep belief network (DBN).

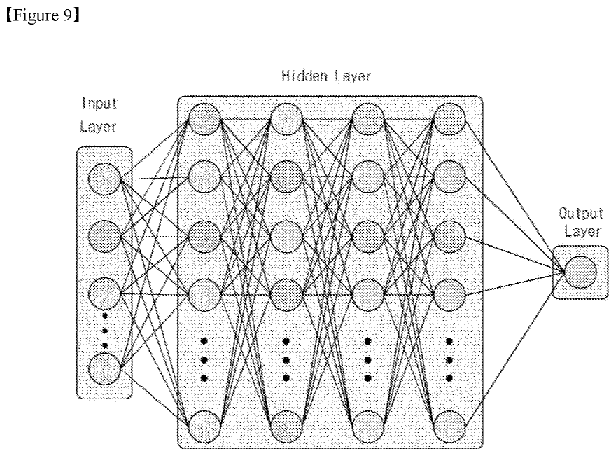

Referring to FIG. 9, the artificial neural network (ANN) may include an input layer, a hidden layer, and an output layer. Each layer may include a plurality of nodes, and may be connected to the next layer. Nodes between adjacent layers may have weights, and may be connected to each other.

An electronic device may construct a feature map by finding a constant pattern in data. The electronic device may recognize a target by extracting lower-level features, intermediate-level features, and higher-level features, and may output the result of recognition.

The respective nodes may be operated based on an activation model, and an output value corresponding to an input value may be determined according to the activation model.

An output value from an arbitrary node, for example, an output value of the lower-level features, may be input to the node of the next layer connected to the corresponding node, for example, the node of the intermediate-level features. The node of the next layer, for example, the node of the intermediate-level features, may receive values output from a plurality of nodes of the lower-level features.

Here, the input values of the respective nodes may be values acquired by applying a weight to the output values of the nodes of the previous layer. The weight may be an intensity of connection between the nodes. Further, a deep-learning process may be considered as a process for finding proper weights and biases.

Furthermore, an output value from an arbitrary node, for example, an output value of the intermediate-level features, may be input to the node of the next layer connected to the corresponding node, for example, the node of the higher-level features. The node of the next layer, for example, the node of the higher-level features, may receive values output from a plurality of nodes of the intermediate-level features.

The artificial neural network (ANN) may extract feature information corresponding to the respective levels using trained layers corresponding to the respective levels. The artificial neural network (ANN) may recognize a designated target using feature information of the uppermost level through sequential abstraction.

Further, training of the artificial neural network (ANN) may be performed by adjusting weights of connection lines between nodes so that desired output is output in response to given input data. If necessary, bias values may also be adjusted. Further, the artificial neural network (ANN) may continuously update the weight values by training. Moreover, methods such as back propagation may be used in training of the artificial neural network (ANN).

The aerosol-generating device 100 may also store data acquired from each component provided in the aerosol-generating device 100 and data for training the artificial neural network (ANN). For example, the memory 140 of the aerosol-generating device 100 may store a database for each component provided in the aerosol-generating device 100 and weights and biases constituting the structure of the artificial neural network (ANN) in order to train the artificial neural network (ANN). Here, the aerosol-generating device 100 may learn data on the values sensed by at least one sensor included in the sensor module 150, the user's inhalation pattern, and the temperature profile, which are stored in the memory 140, and may generate at least one learning model used to determine the user's inhalation pattern and generate the temperature profile.

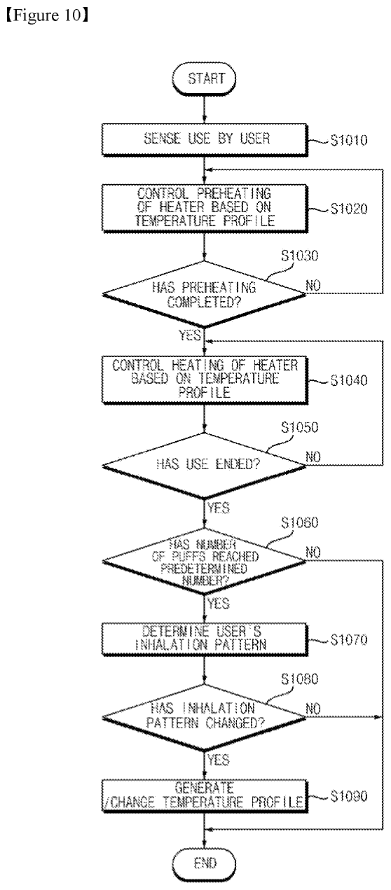

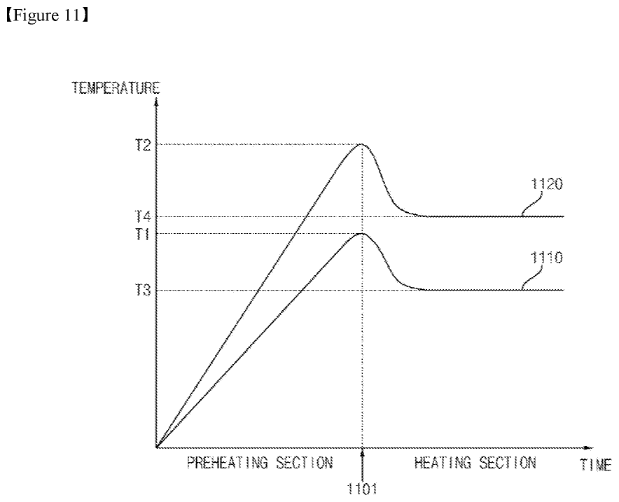

FIG. 10 is a flowchart showing an operation method of the aerosol-generating device according to another embodiment of the present disclosure, and FIG. 11 is a view for explaining the operation method shown in FIG. 10. A detailed description of the same content as that described with reference to FIG. 5 will be omitted.

Referring to FIG. 10, the aerosol-generating device 100 may sense use thereof by the user in operation S1010. For example, the aerosol-generating device 100 may sense use thereof by the user when insertion of a cigarette thereinto is sensed by the cigarette detection sensor or when a command to turn on the power is received through the input device.

When use thereof by the user is sensed, the aerosol-generating device 100 may initiate a preheating section to activate the heater of the aerosol-generating module 130 to perform preheating in operation S1020.

When the preheating section is initiated, the aerosol-generating device 100 may increase the temperature of the heater to a target temperature in the preheating section based on the temperature profile corresponding to the user's inhalation pattern, which is stored in the memory 140.

For example, the aerosol-generating device 100 may perform control such that electric power is supplied to the heater in an amount per unit time preset for the preheating section during a predetermined preheating time period from the time point at which use thereof by the user was sensed, for example, the time point at which insertion of a cigarette was sensed or the time point at which user input was received through the input/output interface 120, so that the temperature of the heater is increased to a target temperature preset in the temperature profile.

For example, the aerosol-generating device 100 may control the electric power supplied to the heater using a PID method from the time point at which use thereof by the user was sensed so that the temperature of the heater is increased to a target temperature preset in the temperature profile.

The target temperature in the preheating section may be preset in the temperature profile so as to change over time within the preheating section.

The aerosol-generating device 100 may determine whether preheating of the heater is completed in operation S1030.

For example, the aerosol-generating device 100 may determine whether the temperature of the heater reaches the target temperature in the preheating section using the temperature sensor included in the sensor module 150. When the temperature of the heater reaches the target temperature in the preheating section, the aerosol-generating device 100 may determine that preheating of the heater has completed.

For example, the aerosol-generating device 100 may monitor the time period for which electric power is supplied to the heater in an amount per unit time preset in the temperature profile. When a predetermined preheating time period has elapsed, the aerosol-generating device 100 may determine that preheating of the heater has completed.

On the other hand, when the temperature of the heater has not reached the target temperature in the preheating section and/or when a predetermined preheating time period has not elapsed, the aerosol-generating device 100 may continuously activate the heater to generate heat to the target temperature in the preheating section.

When preheating of the heater is completed, for example, when the temperature of the heater reaches the target temperature in the preheating section and/or when the preheating time period has elapsed, the aerosol-generating device 100 may output a message indicating completion of preheating through the output device of the input/output interface 120. For example, the aerosol-generating device 100 may generate a vibration corresponding to completion of preheating using a motor.

The aerosol-generating device 100 may terminate the preheating section and may initiate a heating section to activate the heater in order to generate an aerosol in operation S1040. Here, the heating section may be composed of a plurality of puff sections corresponding to user inhalation.

When the heating section is initiated, the aerosol-generating device 100 may control the electric power supplied to the heater based on the temperature profile corresponding to the user's inhalation pattern, which is stored in the memory 140.

For example, the aerosol-generating device 100 may determine a target temperature in the heating section according to the temperature profile stored in the memory 140, and may control the electric power supplied to the heater using a PID method so that the temperature of the heater is maintained at a level equivalent to the target temperature in the heating section. Here, the target temperature in the heating section may be changed according to the plurality of puff sections.

While controlling the electric power supplied to the heater based on the temperature profile in the heating section, the aerosol-generating device 100 may determine whether a puff is sensed and may monitor the number of puffs using at least one sensor included in the sensor module 150.

The aerosol-generating device 100 may determine whether use thereof by the user ends in operation S1050. For example, the aerosol-generating device 100 may determine that use thereof by the user has ended when removal of the cigarette is sensed by the cigarette detection sensor, when a predetermined time period (e.g. 5 minutes) has elapsed from the time point at which use thereof by the user was sensed, or when the number of puffs reaches the maximum number of puffs.

When use thereof by the user ends, the aerosol-generating device 100 may determine whether the number of puffs taken by the user is equal to or greater than a predetermined number of puffs in operation S1060. Here, the predetermined number of puffs may be set to a number between 1 and the maximum number of puffs.

When the number of puffs taken by the user is equal to or greater than the predetermined number of puffs, the aerosol-generating device 100 may determine a user's inhalation pattern in operation S1070. For example, the aerosol-generating device 100 may calculate the user's inhalation intensity, the total inhalation amount, the inhalation amount per unit time, the puff interval, and/or the inhalation time period based on the values sensed by at least one sensor, which are stored in the memory 140.

The aerosol-generating device 100 may determine whether the user's inhalation pattern changes in operation S1080.

When the user's inhalation pattern changes, the aerosol-generating device 100 may generate a temperature profile corresponding to the changed inhalation pattern and may replace the temperature profile pre-stored in the memory 140 with the generated temperature profile in operation S1090. For example, the aerosol-generating device 100 may determine a target temperature and/or an amount of electric power per unit time in the preheating section based on the inhalation intensity, the total inhalation amount, the inhalation amount per unit time, the puff interval, and/or the inhalation time period calculated for the initial puff section in which a puff was initially sensed.

For example, the aerosol-generating device 100 may determine a target temperature and/or an amount of electric power per unit time in the heating section based on the user's inhalation intensity, the total inhalation amount, the inhalation amount per unit time, the puff interval, and/or the inhalation time period, calculated for the plurality of puff sections.

Also, when the user's inhalation pattern changes, the aerosol-generating device 100 may determine a temperature profile corresponding to the changed inhalation pattern, among the plurality of temperature profiles pre-stored in the memory 140.

FIG. 11 is a view showing graphs indicating a change in the temperature of the heater according to various inhalation patterns of the user.

In FIG. 11, a first graph 1110 corresponds to a first inhalation pattern in which the inhalation intensity is relatively low and the inhalation time period is relatively long, and a second graph 1120 corresponds to a second inhalation pattern in which the inhalation intensity is relatively high and the inhalation time period is relatively short. Here, the user's total inhalation amount in the first inhalation pattern and the user's total inhalation amount in the second inhalation pattern may be equal to each other.

When the user's inhalation pattern changes from the first inhalation pattern, in which the inhalation intensity is relatively low and the inhalation time period is relatively long, to the second inhalation pattern, in which the inhalation intensity is relatively high and the inhalation time period is relatively short, the aerosol-generating device 100 enables the user to inhale a relatively large amount of aerosol in a relatively short time period, and the user is also capable of expecting to inhale a large amount of aerosol in a short time period.

In consideration of this, when the user's inhalation pattern changes from the first inhalation pattern to the second inhalation pattern, the aerosol-generating device 100 may activate the heater to generate heat to a second target temperature T2, which is higher than a first target temperature T1 corresponding to the first inhalation pattern, in the preheating section based on the temperature profile corresponding to the second inhalation pattern.

For example, the aerosol-generating device 100 may supply an amount of electric power per unit time larger than the amount of electric power per unit time corresponding to the first inhalation pattern to the heater so that the heater generates heat to the second target temperature T2, higher than the first target temperature T1, during a time period from the time point at which use thereof by the user was sensed to an ending time 1101 of the preheating section.

Also, the aerosol-generating device 100 may control the electric power supplied to the heater using a PID method so that the temperature of the heater is maintained at a fourth target temperature T4, which is higher than a third target temperature T3 corresponding to the first inhalation pattern, in the heating section based on the temperature profile corresponding to the second inhalation pattern.

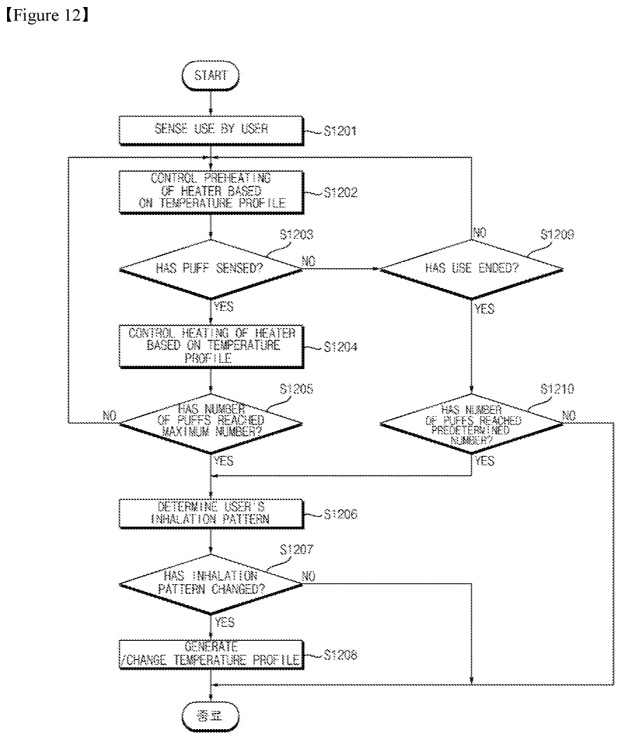

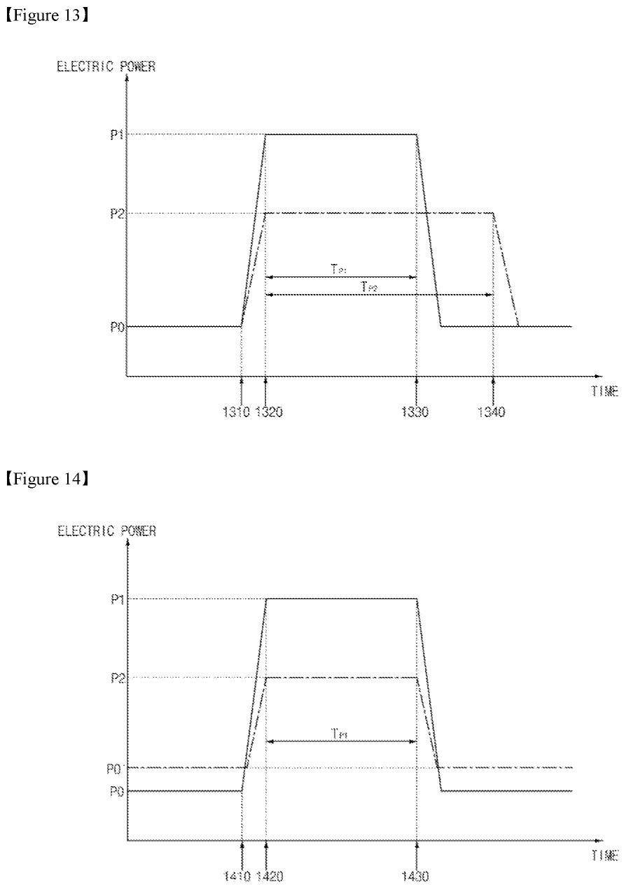

FIG. 12 is a flowchart showing an operation method of the aerosol-generating device according to another embodiment of the present disclosure, and FIGS. 13 and 14 are views for explaining the operation method shown in FIG. 12. A detailed description of the same content as that described with reference to FIG. 5 will be omitted.

Referring to FIG. 12, the aerosol-generating device 100 may sense use thereof by the user in operation S1201. For example, the aerosol-generating device 100 may sense use thereof by the user when a command to turn on the power is received through the input device.

When use thereof by the user is sensed, the aerosol-generating device 100 may activate the heater of the aerosol-generating module 130 to perform preheating in operation S1202.

For example, the aerosol-generating device 100 may supply an amount of electric power preset for the preheating section (hereinafter referred to as “preheating electric power”) to the heater based on the temperature profile stored in the memory 140. Here, the preheating electric power may be electric power corresponding to a predetermined portion (e.g. 5%) of the maximum electric power that is capable of being supplied to the heater.

For example, the aerosol-generating device 100 may determine a target temperature in the preheating section based on the temperature profile stored in the memory 140. Here, the aerosol-generating device 100 may control the electric power supplied to the heater using a PID method so that the temperature of the heater is maintained at a temperature equivalent to the target temperature in the preheating section.

On the other hand, according to another embodiment, the aerosol-generating device 100 may omit operation S1202 of activating the heater to perform preheating.

The aerosol-generating device 100 may determine whether a puff is sensed using at least one sensor included in the sensor module 150 in operation 51203.

When a puff is sensed, the aerosol-generating device 100 may activate the heater to generate heat based on the temperature profile stored in the memory 140 in operation S1204.

For example, the aerosol-generating device 100 may perform control such that electric power is supplied from the battery 160 to the heater in an amount per unit time preset for the heating section, thereby activating the heater to generate heat based on the temperature profile stored in the memory 140. Here, the aerosol-generating device 100 may supply electric power to the heater in an amount per unit time preset for the heating section while a puff is sensed or during a predetermined time period from the time point at which the puff was sensed (hereinafter referred to as a “heating time period”).

For example, the aerosol-generating device 100 may determine a target temperature in the heating section based on the temperature profile stored in the memory 140. Here, the aerosol-generating device 100 may control the electric power supplied to the heater using a PID method so that the temperature of the heater is increased to and/or maintained at a temperature equivalent to the target temperature in the heating section.

Also, the aerosol-generating device 100 may monitor the temperature of the heater using the temperature sensor while the heater generates heat. When the temperature of the heater exceeds a predetermined threshold temperature, the aerosol-generating device 100 may interrupt the supply of electric power to the heater. Here, the predetermined threshold temperature may be a temperature equivalent to the minimum temperature of the heater at which at least one component provided in the aerosol-generating module 130 is damaged.

The aerosol-generating device 100 may determine whether the number of puffs reaches the maximum number of puffs in operation S1205. For example, the aerosol-generating device 100 may monitor the number of puffs from the time point at which the first puff was sensed, and may update the number of puffs whenever a puff is sensed.

When the number of puffs has not reached the maximum number of puffs, the aerosol-generating device 100 proceeds to operation S1202 to activate the heater to perform preheating based on the temperature profile, and may continuously determine whether a puff is sensed.

Also, the aerosol-generating device 100 may store the values sensed by at least one sensor included in the sensor module 150 in the memory 140 until the number of puffs reaches the maximum number of puffs.

When the number of puffs reaches the maximum number of puffs, the aerosol-generating device 100 may determine a user's inhalation pattern in operation S1206.

The aerosol-generating device 100 may calculate the user's inhalation intensity, the total inhalation amount, the inhalation amount per unit time, the puff interval, and/or the inhalation time period based on the values sensed by at least one sensor, which are stored in the memory 140.

The aerosol-generating device 100 may determine whether the user's inhalation pattern changes in operation S1207.

When the user's inhalation pattern changes, the aerosol-generating device 100 may generate a temperature profile corresponding to the changed inhalation pattern and may replace the temperature profile pre-stored in the memory 140 with the generated temperature profile in operation S1208.

For example, the aerosol-generating device 100 may determine a target temperature in each section, an amount of electric power supplied to the heater per unit time in each section, and/or a heating time period for which electric power is supplied in the determined amount per unit time based on the user's inhalation intensity, the total inhalation amount, the inhalation amount per unit time, the puff interval, and/or the inhalation time period, and may generate a temperature profile according to the determined target temperature, the determined amount of electric power per unit time, and/or the determined heating time period.

Also, when the user's inhalation pattern changes, the aerosol-generating device 100 may determine a temperature profile corresponding to the changed inhalation pattern, among the plurality of temperature profiles pre-stored in the memory 140.

FIG. 13 is a view showing graphs indicating an amount of electric power supplied to the heater per unit time according to various inhalation patterns of the user.

FIG. 13 shows a graph corresponding to an inhalation pattern in which the inhalation intensity is relatively high and the inhalation time period is relatively short and a graph corresponding to an inhalation pattern in which the inhalation intensity is relatively low and the inhalation time period is relatively long. Here, the user's total inhalation amount and the puff interval in one inhalation pattern may be equal to those in the other inhalation pattern.

In the case of a user's inhalation pattern in which the inhalation intensity is high and the inhalation time period is short, the amount of electric power per unit time corresponding to the heating section may be determined to be P1, and the heating time period may be determined to be Tp1.

When a puff is sensed at a first time point 1310, the aerosol-generating device 100 may increase the amount of electric power supplied to the heater per unit time to P1, and may supply electric power to the heater in the amount P1 per unit time during the heating time period Tp1 from a second time point 1320. At this time, the temperature of the heater may continuously increase during the heating time period Tp1 from the second time point 1320 to a third time point 1330. Here, the difference between the first time point 1310 and the second time point 1320 may be determined according to the performance of each of the components provided in the aerosol-generating device 100 and the signal transmission/reception time.

When the user's inhalation pattern changes from an inhalation pattern in which the inhalation intensity is relatively large and the inhalation time period is relatively short to an inhalation pattern in which the inhalation intensity is relatively low and the inhalation time period is relatively long, the amount of electric power per unit time corresponding to the heating section may be determined to be P2, which is smaller than P1, and the heating time period may be determined to be Tp2, which is longer than Tp1.

In this case, when a puff is sensed at the first time point 1310, the aerosol-generating device 100 may increase the amount of electric power supplied to the heater per unit time to P2, and may supply electric power to the heater in the amount P2 per unit time during the heating time period Tp2 from the second time point 1320. At this time, the temperature of the heater may continuously increase during the heating time period Tp2 from the second time point 1320 to a fourth time point 1340.

Also, referring to FIG. 14, the aerosol-generating device 100 may change the preheating electric power in response to the change in the user's inhalation pattern.

The aerosol-generating device 100 may set the preheating electric power to an amount of electric power corresponding to a predetermined proportion of the maximum electric power that is capable of being supplied to the heater.

For example, when the user's inhalation pattern changes from an inhalation pattern in which the inhalation intensity is relatively high and the total inhalation amount is relatively large to an inhalation pattern in which the inhalation intensity is relatively low and the total inhalation amount is relatively small, the aerosol-generating device 100 may change the preheating electric power from electric power P0 corresponding to 5% of the maximum electric power to electric power P0′ corresponding to 7% of the maximum electric power. In this case, the aerosol-generating device 100 may perform control such that electric power P0′ is supplied to the heater while a puff is not sensed.

Also, when a puff is sensed at a first time point 1410, the aerosol-generating device 100 may increase the amount of electric power supplied to the heater per unit time to P2, and may supply electric power to the heater in the amount P2 per unit time during the heating time period Tp1 from a second time point 1420. At this time, the temperature of the heater may continuously increase during the heating time period Tp1 from the second time point 1420 to a third time point 1430.

Also, the aerosol-generating device 100 may perform control such that the electric power P0′ is supplied to the heater until the time point at which the next puff is sensed.

Also, when the user's inhalation pattern changes, the aerosol-generating device 100 may calculate the maximum number of puffs taken by the user based on the temperature profile corresponding to the changed inhalation pattern.

For example, the aerosol-generating device 100 may calculate the amount of electric power that is consumed when the user inhales once, based on the electric power per unit time corresponding to the preheating section, the electric power per unit time corresponding to the heating section, the heating time period, and the puff interval. Here, the aerosol-generating device 100 may compare the total amount of electric power consumed according to the number of puffs with the maximum charge capacity of the battery 160 to determine the maximum number of puffs.

Also, when the determined maximum number of puffs and the currently preset maximum number of puffs are different from each other, the aerosol-generating device 100 may output a suggestion message, including information about the change in the maximum number of puffs, through the output device. At this time, when user input to change the temperature profile stored in the memory 140 is received through the input device of the input/output interface 120, the aerosol-generating device 100 may change the temperature profile pre-stored in the memory 140 to a temperature profile corresponding to the changed inhalation pattern.

Referring again to FIG. 12, when a puff is not sensed, the aerosol-generating device 100 may determine whether use thereof by the user ends in operation S1209.

For example, the aerosol-generating device 100 may determine that use thereof by the user has ended when a command to turn off the power is received through the input device, when a puff is not sensed during a predetermined time period (e.g. 1 minute) from the time point at which the most recent puff was sensed, or when a predetermined time period (e.g. 5 minutes) has elapsed from the time point at which use thereof by the user was sensed.

When use thereof by the user has ended, the aerosol-generating device 100 may determine whether the number of puffs taken by the user is equal to or greater than a predetermined number of puffs in operation S1210.

When the number of puffs taken by the user is equal to or greater than the predetermined number of puffs, the aerosol-generating device 100 may determine that an amount of data sufficient to use to determine the user's inhalation pattern has been stored in the memory 140, and may determine the user's inhalation pattern.

On the other hand, when use thereof by the user ends before the number of puffs has reached the maximum number of puffs, the aerosol-generating device 100 may determine that an amount of data sufficient to use to determine the user's inhalation pattern has not been stored in the memory 140, and may not change the temperature profile stored in the memory 140.

FIG. 15 is a flowchart showing an operation method of the aerosol-generating device according to another embodiment of the present disclosure. A detailed description of the same content as that described with reference to FIG. 5 will be omitted.

Referring to FIG. 15, the aerosol-generating device 100 may sense use thereof by the user in operation S1510.

When use thereof by the user is sensed, the aerosol-generating device 100 may supply electric power to the heater of the aerosol-generating module 130 based on the temperature profile stored in the memory 140 in operation 1520.

While electric power is being supplied to the heater of the aerosol-generating module 130, the aerosol-generating device 100 may determine whether a puff is sensed using at least one sensor included in the sensor module 150.

Also, while electric power is being supplied to the heater of the aerosol-generating module 130, the aerosol-generating device 100 may store the values sensed by at least one sensor included in the sensor module 150 in the memory 140.

The aerosol-generating device 100 may determine whether use thereof by the user ends in operation S1530.

When use thereof by the user ends, the aerosol-generating device 100 may determine a user's inhalation pattern in operation 1540.

The aerosol-generating device 100 may determine whether the user's inhalation pattern changes in operation S1550.

When the user's inhalation pattern changes, the aerosol-generating device 100 may change the temperature profile corresponding to the user's inhalation pattern in operation S1560.

For example, the aerosol-generating device 100 may select one of the plurality of temperature profiles pre-stored in the memory 140 as the temperature profile corresponding to the user's inhalation pattern based on the user's inhalation intensity, the total inhalation amount, the inhalation amount per unit time, the puff interval, and/or the inhalation time period.

For example, as the user's inhalation intensity increases, the aerosol-generating device 100 may determine the temperature profile having the highest target temperature in the heating section, among the plurality of temperature profiles pre-stored in the memory 140, to be the temperature profile corresponding to the user's inhalation pattern.

For example, as the user's total inhalation amount increases, the aerosol-generating device 100 may determine the temperature profile having the lowest electric power per unit time in the preheating section and the highest electric power per unit time in the heating section, among the plurality of temperature profiles pre-stored in the memory 140, to be the temperature profile corresponding to the user's inhalation pattern.

For example, as the user's puff interval increases, the aerosol-generating device 100 may determine the temperature profile having the lowest electric power per unit time in the preheating section, among the plurality of temperature profiles pre-stored in the memory 140, to be the temperature profile corresponding to the user's inhalation pattern.

As described above, according to at least one of the embodiments of the present disclosure, a temperature profile corresponding to the user may be generated based on a user's inhalation pattern, such as an inhalation intensity or an inhalation time period, and thereafter, when the user inhales an aerosol, the electric power supplied to the heater may be controlled based on the temperature profile corresponding to the user, thus providing an optimum amount of smoke to the user.

In addition, according to at least one of the embodiments of the present disclosure, a target temperature and an amount of electric power per unit time may be optimized according to the preheating section of the temperature profile and the heating section of the temperature profile based on the user's inhalation pattern, thereby providing an amount of smoke more suitable for the user's inhalation pattern.

In addition, according to at least one of the embodiments of the present disclosure, whether the user's inhalation pattern changes may be monitored, and whether to optimize an existing setting according to the changed inhalation pattern may be suggested to the user, thereby increasing the reliability of the product and improving user satisfaction therewith.

Referring to FIGS. 1 to 15, an aerosol-generating device 100 in accordance with one aspect of the present disclosure may include an aerosol-generating module 130 including at least one heater configured to heat an aerosol-generating substance, a memory 140, a sensor module 150 including at least one sensor configured to sense inhalation by a user, a battery 160 configured to supply electric power to the at least one heater, and a controller 170 configured to control the electric power supplied to the at least one heater. The controller 170 may determine an inhalation pattern associated with inhalation by the user based on a signal received from the sensor module 150, may determine a temperature profile corresponding to the inhalation pattern based on the determined inhalation pattern when the determined inhalation pattern differs from a previous inhalation pattern, and may control the electric power supplied to the at least one heater based on the temperature profile corresponding to the inhalation pattern.

In addition, in accordance with another aspect of the present disclosure, the memory 140 may store a plurality of temperature profiles, and the controller 170 may determine the temperature profile corresponding to the inhalation pattern, among the plurality of temperature profiles.

In addition, in accordance with another aspect of the present disclosure, the controller 170 may generate the temperature profile corresponding to the inhalation pattern, and may store the generated temperature profile in the memory 140.

In addition, in accordance with another aspect of the present disclosure, the controller 170 may calculate at least one of an inhalation intensity, an inhalation amount, a puff interval, or an inhalation time period based on a sensing value included in a signal received from the sensor module 150, and may determine the inhalation pattern based on at least one of the calculated inhalation intensity, the calculated inhalation amount, the calculated puff interval, or the calculated inhalation time period.

In addition, in accordance with another aspect of the present disclosure, the controller 170 may determine a puff starting time and a puff ending time based on a slope for the sensing value, may calculate a difference between the puff starting time and the puff ending time as the inhalation time period, and may calculate at least one of the inhalation intensity or the inhalation amount based on at least one of a slope for the sensing value during the inhalation time period, a sensing value corresponding to the puff starting time, or a sensing value corresponding to the puff ending time.

In addition, in accordance with another aspect of the present disclosure, the controller 170 may determine at least one of a target temperature or an amount of electric power supplied to the at least one heater per unit time in a preheating section based on at least one of the inhalation intensity, the inhalation amount, the puff interval, or the inhalation time period calculated for a first puff section, among a plurality of puff sections constituting a time period from the time point at which use by the user starts to the time point at which use by the user ends, and may determine the temperature profile according to at least one of the target temperature or the amount of electric power per unit time in the preheating section.

In addition, in accordance with another aspect of the present disclosure, the controller 170 may determine at least one of a target temperature or an amount of electric power supplied to the at least one heater per unit time in a heating section based on at least one of the inhalation intensity, the inhalation amount, the puff interval, or the inhalation time period calculated for each of a plurality of puff sections constituting a time period from the time point at which use by the user starts to the time point at which use by the user ends, and may determine the temperature profile according to at least one of the target temperature or the amount of electric power per unit time in the heating section.

In addition, in accordance with another aspect of the present disclosure, the aerosol-generating device may further include an input device configured to receive user input and an output device configured to output a message. When the determined inhalation pattern differs from the previous inhalation pattern, the controller 170 may output a suggestion message suggesting a change in a setting according to a change in the inhalation pattern through the output device. When user input to change the setting is received through the input device, the controller 170 may determine a temperature profile corresponding to the user based on the determined inhalation pattern.

In addition, in accordance with another aspect of the present disclosure, the controller 170 may compare a representative value of at least one of the inhalation intensity, the inhalation amount, the puff interval, or the inhalation time period calculated for each of the plurality of puff sections with a representative value of at least one of the inhalation intensity, the inhalation amount, the puff interval, or the inhalation time period corresponding to the previous inhalation pattern to determine whether the determined inhalation pattern differs from the previous inhalation pattern.

In addition, in accordance with another aspect of the present disclosure, the aerosol-generating device may further include an output device configured to output a message. The controller 170 may calculate the maximum number of puffs taken by the user based on the temperature profile corresponding to the inhalation pattern. When the calculated maximum number of puffs differs from the preset maximum number of puffs, the controller 170 may output a message including information about the calculated maximum number of puffs through the output device.

In addition, in accordance with another aspect of the present disclosure, the controller 170 may calculate an amount of electric power consumed during a puff based on the temperature profile corresponding to the inhalation pattern, and may compare the calculated amount of electric power with the maximum charge capacity of the battery 160 to calculate the maximum number of puffs.

In addition, in accordance with another aspect of the present disclosure, the controller 170 may calculate the number of puffs taken by the user based on a signal received from the sensor module 150. When the number of puffs reaches a predetermined number of puffs, the controller 170 may determine an inhalation pattern associated with inhalation by the user. When use by the user ends in the state in which the number of puffs is less than the predetermined number of puffs, the controller 170 may omit determination of the inhalation pattern.

In addition, in accordance with another aspect of the present disclosure, the controller 170 may generate a learning model to determine the temperature profile. After the learning model is generated, the controller 170 may input a signal received from the sensor module 150 to the learning model to determine the temperature profile corresponding to the inhalation pattern.

In addition, in accordance with another aspect of the present disclosure, the aerosol-generating device 100 may further include a communication interface 110 including at least one communication module. The controller 170 may transmit data on a signal received from the sensor module 150 to a server through the communication interface 110. When a learning model used to determine the temperature profile is received from the server through the communication interface 110, the controller 170 may store the learning model in the memory 140. After the learning model is received, the controller 170 may input a signal received from the sensor module 150 to the learning model to determine the temperature profile corresponding to the inhalation pattern.

In addition, an operation method of the aerosol-generating device 100 in accordance with one aspect of the present disclosure may include an operation of determining an inhalation pattern associated with inhalation by a user based on a signal received from a sensor module including at least one sensor configured to sense inhalation by the user, an operation of determining a temperature profile corresponding to the inhalation pattern based on the determined inhalation pattern when the determined inhalation pattern differs from a previous inhalation pattern, and an operation of supplying electric power to a heater configured to heat an aerosol-generating substance based on the temperature profile corresponding to the inhalation pattern.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
at least one heater configured to heat an aerosol-generating substance;
a battery configured to supply electric power to the at least one heater;
at least one sensor configured to sense inhalation by a user;
a memory; and
a controller configured to control the electric power supplied to the at least one heater,
wherein the controller is further configured to:
determine an inhalation pattern associated with the inhalation by the user based on a signal received from the at least one sensor;
determine a temperature profile corresponding to the inhalation pattern based on the determined inhalation pattern in response to the determined inhalation pattern differing from a previous inhalation pattern; and
control the electric power supplied to the at least one heater based on the temperature profile corresponding to the inhalation pattern.

2. The aerosol-generating device according to claim 1, wherein the memory is configured to store a plurality of temperature profiles, and
wherein the controller is further configured to determine the temperature profile corresponding to the inhalation pattern from among the plurality of temperature profiles.

3. The aerosol-generating device according to claim 1, wherein the controller is further configured to:
generate the temperature profile corresponding to the inhalation pattern; and
store the generated temperature profile in the memory.

4. The aerosol-generating device according to claim 1, wherein the controller is further configured to:
calculate at least one of an inhalation intensity, an inhalation amount, a puff interval, or an inhalation time period based on a sensing value included in a signal received from the at least one sensor; and
determine the inhalation pattern based on at least one of the calculated inhalation intensity, the calculated inhalation amount, the calculated puff interval, or the calculated inhalation time period.

5. The aerosol-generating device according to claim 4, wherein the controller is further configured to:
determine a puff starting time and a puff ending time based on a slope of the sensing value;
calculate a difference between the puff starting time and the puff ending time as the inhalation time period; and
calculate at least one of the inhalation intensity or the inhalation amount based on at least one of a slope of the sensing value during the inhalation time period, the sensing value corresponding to the puff starting time, or the sensing value corresponding to the puff ending time.

6. The aerosol-generating device according to claim 4, wherein the controller is further configured to:
determine at least one of a target temperature or an amount of electric power supplied to the at least one heater per unit time in a preheating section based on at least one of the inhalation intensity, the inhalation amount, the puff interval, or the inhalation time period calculated for a first puff section of a plurality of puff sections constituting a time period from a time at which a use by the user starts to a time at which the use by the user ends; and
determine the temperature profile according to the determined at least one of the target temperature or the amount of electric power supplied per unit time in the preheating section.

7. The aerosol-generating device according to claim 4, wherein the controller is further configured to:
determine at least one of a target temperature or an amount of electric power supplied to the at least one heater per unit time in a heating section based on at least one of the inhalation intensity, the inhalation amount, the puff interval, or the inhalation time period calculated for each of a plurality of puff sections constituting a time period from a time at which a use by the user starts to a time at which the use by the user ends; and
determine the temperature profile according to the determined at least one of the target temperature or the amount of electric power supplied per unit time in the heating section.

8. The aerosol-generating device according to claim 1, further comprising:
an input device configured to receive a user input; and
an output device configured to output a message,
wherein the controller is further configured to:
in response to the determined inhalation pattern differing from the previous inhalation pattern, output a suggestion message suggesting changing a setting according to a change in the inhalation pattern via the output device; and
in response to receiving a user input to change the setting via the input device, determine a temperature profile corresponding to the user based on the determined inhalation pattern.

9. The aerosol-generating device according to claim 4, wherein the controller is further configured to compare a representative value of at least one of the inhalation intensity, the inhalation amount, the puff interval, or the inhalation time period calculated for each of a plurality of puff sections with a representative value of at least one of an inhalation intensity, an inhalation amount, a puff interval, or an inhalation time period corresponding to the previous inhalation pattern to determine whether the determined inhalation pattern differs from the previous inhalation pattern.

10. The aerosol-generating device according to claim 1, further comprising:
an output device configured to output a message,
wherein the controller is further configured to:
calculate a maximum number of puffs taken by the user based on the temperature profile corresponding to the inhalation pattern; and
in response to the calculated maximum number of puffs differing from a preset maximum number, output a message including information about the calculated maximum number of puffs via the output device.

11. The aerosol-generating device according to claim 10, wherein the controller is further configured to:
calculate an amount of electric power consumed during a puff based on the temperature profile corresponding to the inhalation pattern; and
compare the calculated amount of electric power with a maximum charge capacity of the battery to calculate the maximum number of puffs.

12. The aerosol-generating device according to claim 1, wherein the controller is further configured to:
calculate a number of puffs taken by the user based on a signal received from the at least one sensor;
in response to the number of puffs reaching a predetermined number, determine an inhalation pattern associated with the inhalation by the user; and
in response to a use by the user ending in a state in which the number of puffs is less than the predetermined number, omit determination of the inhalation pattern.

13. The aerosol-generating device according to claim 1, wherein the controller is further configured to:
generate a learning model to determine the temperature profile; and
after the learning model is generated, input a signal received from the at least one sensor to the learning model to determine the temperature profile corresponding to the inhalation pattern.

14. The aerosol-generating device according to claim 1, further comprising:
a communication interface comprising at least one antenna,
wherein the controller is further configured to:
transmit data regarding a signal received from the sensor device to a server via the communication interface;
in response to receiving a learning model configured to determine the temperature profile from the server via the communication interface, store the learning model in the memory; and
after the learning model is received, input a signal received from the sensor device to the learning model to determine the temperature profile corresponding to the inhalation pattern.

15. An operation method of an aerosol-generating device, the method comprising:
determining an inhalation pattern associated with inhalation by a user based on a signal received from at least one sensor configured to sense the inhalation by the user;
determining a temperature profile corresponding to the inhalation pattern based on the determined inhalation pattern in response to the determined inhalation pattern differing from a previous inhalation pattern; and
supplying electric power to at least one heater configured to heat an aerosol-generating substance based on the temperature profile corresponding to the inhalation pattern.
